(19) United States
(12) Patent Application Publication
(10) Pub. No.: US 2006/0066819 A1
(43) Pub. Date: Mar. 30, 2006

(54) SINGLE REFLECTIVE LIGHT VALVE PROJECTION DEVICE

(76) Inventors: Shen-Huei Wang, Miao-Li County (TW); Tzung-I Lin, Miao-Li County (TW); Sze-Ke Wang, Miao-Li County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/160,925

(22) Filed: Jul. 15, 2005

(30) Foreign Application Priority Data
Sep. 27, 2004 (TW) 93129184

(51) Int. Cl. G03B 21/28

(52) U.S. Cl. 353/99

(57) ABSTRACT

A single reflective light valve projection device comprising a non-telecentric lighting system, a projection lens and a reflective light valve is provided. The non-telecentric lighting system comprises a light source and a lens. The light source provides a light beam. The lens is disposed in the transmission path of the light beam. The projection lens is disposed behind the lens and in the transmission path of the light beam. The reflective light valve is disposed between the lens of the non-telecentric lighting system and the projection lens and in the transmission path of the light beam. The reflective light valve comprises many horizontally aligned rows of pixels. A line joining the center of the projection lens to the center of the lens forms an angle smaller than π/4 with respect to a horizontal line to provide side projection in the horizontal direction.

### CROSS-REFERENCE TO RELATED APPLICATION

This application claims the priority benefit of Taiwan application serial no. 93129184, filed on Sep. 27, 2004. All disclosure of the Taiwan application is incorporated herein by reference.

### BACKGROUND OF THE INVENTION

1. Field of the Invention

The present invention relates to a projection device having a single reflective light valve. More particularly, the present invention relates to a single reflective light valve projection device with low cost and suitable for side projection.

2. Description of the Related Art

In recent years, bulky and heavy cathode ray tube (CRT) projection devices have been gradually replaced by LCD projectors and digital light processing (DLP) projectors. These products are not only light and portable, but also can be directly connected with other digital products to display images. With the fierce competition among manufacturers, many cheap projectors having a variety of additional functions suitable for projecting images in offices, school premises or some public places are introduced. Gradually, these projectors are also adopted for family use as well.

FIG. 1 is a schematic drawing of a conventional side-projection device having large offset. In general, projection devices have to be placed in front of a screen at an almost center position to project an undistorted rectangular image on the screen. For example, to watch a movie in a family parlor using a projection device 50, the projection device 50 must be positioned on a desk 60 right in front of a screen 400 to project a rectangular-like image. However, the projection device 50 has a power cable and other signaling lines, which might cause users walking across to fall down, or the projection device 50 can be pulled onto the floor and smashed. Therefore, a projection device 50a having a side projection capacity of a large angle is preferred because the projection device 50a can be placed on a coffee table 70 on one side of the room. Since the coffee table 70 is placed in a corner of the family parlor, the chance of users to be tripped by the connecting cables and wires or the projection device 50a to be pulled down on the floor is greatly minimized. Moreover, with the projection device 50a disposed elsewhere, the desk 60 can have more room for other usage.

FIG. 2 is a diagram showing a plurality of projected images at various projecting angles from a conventional single reflective light valve projection device controlled by an electronic compensation system. As shown in FIG. 2, most projection devices having a conventional single reflective light valve provide two types of adjustments for the top, bottom, left or right projecting angles such that the projected image and the reflective light valve have a proportionate shape. The first type of adjustment is an electronic compensation method that mainly utilizes an internal control unit within the projection device to correct the projected image. In a conventional projection device with a single reflective light valve, the image 300 has a rectangular shape when the projection device projects in the front screen. However, when the projection device projects to the left, the image 300a has a wide left side and a narrow right side. The electronic compensation system then compresses the upper end 306 and the lower end 308 toward the center so that the left side 302 and the right side 304 of the image 300a can be of equal length. Similarly, when the projection device projects to the right, the top and the bottom, the electronic compensation system corrects the images 300b, 300c and 300d into rectangular-like images. However, the corrected image will be smaller than the original image and with lower brightness level. Furthermore, the corrected image will produce distorted electrical signals such as a toothed shape, and ultimately lead to image distortion.

The second type of adjustment is an optical means, where the relative position between the projection lens and the reflective light valve are modified so that the projected image can shift to the top, the bottom, the left or the right. Although this method of adjustment will not lead to problems such as image distortion, a distortion of electrical signals, a reduced image size or lower brightness level, however, the projection lens must cover the reflective light valve and its offset range and thus a larger projection lens is required. Yet, a larger projection lens has a higher price. In other words, for the image to have a wider shifting range, the cost of projection lens is higher.

FIG. 3 is a diagram showing the structural layout of a conventional single reflective light valve projection device. As shown in FIG. 3, a conventional projection device 100a having a single reflective light valve for shifting the image through an optical means includes a digital micro-mirror device (DMD) 110, a projection lens 120 and a telecentric illumination system 130. The telecentric illumination system 130 has a light source 132 suitable for providing a light beam 132a. The projection lens 120 is disposed in the transmission path of the light beam 132a. The telecentric illumination system 130 is disposed between the digital micro-mirror device (DMD) 110 and the movable projection lens 120. The telecentric illumination system 130 has a total internal reflection prism (TIR prism) 134 disposed in front of the DMD 110 and in the transmission path of the light beam 132a.

The light beam 132a provided by the light source 132 passes into the total internal reflection prism 134 and is reflected to the DMD 110. The DMD 110 has a plurality of pixel units, each of which has at least an ‘ON’ state and an ‘OFF’ state. When a pixel unit is in an ‘OFF’ state, the light beam 132a will be reflected away from the projection lens 120 by the pixel unit. On the other hand, when a pixel unit is in an ‘ON’ state, the light beam 132a will be reflected back into the total internal reflection prism 134 by the pixel unit so that an image is projected onto a screen 400 via the projection lens 120.

In the aforementioned projection device 100a, the projection lens 120 can move up and down along the Y-axis or shift left and right along the X-axis. Hence, most projection devices having an image-shifting function use this type of structural design. However, the telecentric illumination system 130 having this type of structural design must use a costly total internal reflection prism 134. Furthermore, the light beam 132a will disperse after reflected by the DMD 110. Thus, a larger projection lens 120 is required to receive the light beam 132a and hence the production cost of the projection device 100a is increased.

In general, for a larger offset of the projection device, the larger projection lens 120 is required, and the cost for producing such projection lens will be higher. To reduce the production cost, the size of the projection lens 120 of the projection device 100a cannot be too large. In other words, the offset of the image is restricted.

FIG. 4 is a diagram showing the maximum degree of shifting an image permitted by a conventional single reflective light valve projection device. As shown in FIGS. 1 and 4, if the projection lens 120 of the conventional projection device 100a moves to the right along the X-axis, the image will move to the right along the X-axis. Because the degree of shifting allowed for the projection lens 120 is limited, the offset of the image 150 is smaller than 100%. In fact, the offset of an image is given by the formula {[(½)A+B]/A}×100%. Since the offset of the image by the conventional projection device 100a is smaller than 100%, it is inconvenient when a large offset projection is required. For example, if the projection device 100a is disposed on the coffee table 70 inside the family parlor (as shown in FIG. 1), an image cannot be projected onto the screen 400 completely.

FIG. 5 is a diagram showing the structural layout of another conventional single reflective light valve projection device. FIG. 6 is a drawing showing the relative positions of the reflective light valve, the lens and the projection lens inside a conventional single reflective light valve projection device. As shown in FIGS. 5 and 6, the structure of the single reflective light valve projection device 100b includes a digital micro-mirror device (DMD) 110, a projection lens 120a and a non-telecentric illumination system 140. The non-telecentric illumination system 140 includes a light source 142 and a lens 144.

In the aforementioned single reflective light valve projection device 100b, the light source 142 provides a light beam 142a and the lens 144 is disposed in the transmission path of the light beam 142a. The projection lens 120a is disposed behind the lens 144 and in the transmission path of the light beam 142a. The reflective light valve is disposed between the lens 144 and the projection lens 120a and in the transmission path of the light beam 142a. The reflective light valve 110 has many rows of pixels aligned along the horizontal line (the X-axis). Furthermore, a connecting line joining the center of the projection lens 120a to the center of the lens 144 forms an angle θ1 smaller than π/4 with a vertical line (the Z-axis).

The light beam 142a provided by the light source 142 converges after passing through the lens 144. The DMD 110 has a plurality of pixel units, each of which has at least an ‘ON’ and an ‘OFF’ state. When a pixel unit is in an ‘ON’ state, the light beam 142a will be reflect to the projection lens 120a by the pixel unit. On the other hand, when a pixel unit is in an ‘OFF’ state, the light beam 142a will not be reflect to the projection lens 120a by the pixel unit. Finally, the light beam 142a reflected from the projection lens 120a is projected onto the screen 400 by a projecting lens 120a.

In the aforementioned projection device 100b, the light beam 142a reflected from the DMD 110 will converge so that a smaller projection lens 120a can be used to collect the light beam 142a to save production cost. Furthermore, because the projection device 100b uses a non-telecentric illumination system 140, the production cost can be reduced because an expensive total internal reflection prism 134 (as shown in FIG. 3) is not required.

As shown in FIGS. 3 and 5, the non-telecentric illumination system 140 of the projection device 100b differs from the telecentric illumination system 130 of the projection device 100a where a total internal reflection prism 134 is used for separating the movable projection lens 120 from other components of the telecentric illumination system 130. Therefore, interference between the lens 144 and the projection lens 120a of the projection device 100b is possible. To prevent such interference, the lens 144 has to be properly cut.

FIG. 7 is a diagram showing the image projected on a screen by another conventional reflective light valve projection device. As shown in FIGS. 6 and 7, a recess 144a is formed at the edge of the lens 144 to prevent any interference between the lens 144 and the projection lens 120a. Due to positional interference between the projection lens 120a and the lens 144, the projection lens 120a is only allowed to move up or down along the Z-axis but is not allowed to move right or left along the X-axis. Hence, the projection device is prevented from performing an offset side projection. Furthermore, the image 150 projected from the projection device having this type of structure will be biased toward the top and the degree of shifting (offset) in the upward direction exceeds 100%. If the projection lens 120a moves further up along the Z-axis, the image will be biased to an even higher location, rendering any upward shifting meaningless. Hence, this type of design structure is more useful for a low-cost projection device without any shifting function.

In a word, it is difficult to perform a large-offset side projection using the conventional single reflective light valve projection device unless modification expenses are increased.

### SUMMARY OF THE INVENTION

The present invention is to provide a low-cost single reflective light valve projection device capable of side projection utilizing the high image projection property of a conventional single reflective light valve projection device.

As embodied and broadly described herein, the invention provides a single reflective light valve projection device suitable for side projection in a horizontal direction. The single reflective light valve projection device includes a non-telecentric illumination system, a projection lens and a reflective light valve. The non-telecentric illumination system further includes a light source and a lens. The light source provides a light beam. The lens is disposed in the transmission path of the light beam. The projection lens is disposed behind the lens and in the transmission path of the light beam. The reflective light valve is disposed between the lens and the projection lens and in the transmission path of the light beam. The reflective light valve has many rows of pixels set along the horizontal direction. Furthermore, a line joining the center of the projection lens and the center of the lens forms an angle with a horizontal line smaller than π/4 so that side projection is possible in a horizontal projection.

In the aforementioned projection device, the reflective light valve is a digital micro-mirror device or a liquid crystal on silicon (LCOS) panel, for example. In addition, the lens is a transparent lens with a curved surface, a reflecting mirror with a flat surface or a reflecting mirror with a curved surface, for example.

In the aforementioned projection device, the light beam converges to a point about 10˜100 mm in front of the reflective light valve. In addition, the degree of horizontal offset in the side projection is greater than 100%, for example.

The present invention also provides another single reflective light valve projection device for side projection along a horizontal line and/or a vertical line. The single reflective light valve projection device includes a non-telecentric illumination system, a projection lens and a reflective light valve. The non-telecentric illumination system further includes a light source and a lens. The light source provides a light beam. The lens is disposed in the transmission path of the light beam. The projection lens is disposed behind the lens and in the transmission path of the light beam. The reflective light valve is disposed between the lens and the projection lens in the transmission path of the light beam. The reflective light valve has many rows of pixels set along a horizontal direction. Furthermore, the projection lens is designed to move horizontally in a direction away from the lens and perform side projection with different degree of horizontal offset.

In the aforementioned projection device, the reflective light valve is a digital micro-mirror device or a liquid crystal on silicon (LCOS) panel, for example. In addition, the lens is a transparent lens with a curved surface, a reflecting mirror with a flat surface or a reflecting mirror with a curved surface, for example.

In the aforementioned projection device, the light beam converges to a point about 10˜100 mm in front of the reflective light valve. In addition, the projection lens is designed to move along a vertical line to perform side projection with different degrees of horizontal as well as vertical offsets.

In brief, the projection lens of the single reflective light valve projection device is disposed on the right side of the lens so that the projected image has a high side offset on the right side for performing right-side projection of a large angle. In another single reflective light valve projection device in the present invention, the projection lens is further designed to move horizontally in a direction away from the lens so that the degree of side offset in the projected image is even greater. Furthermore, the projection lens is also allowed to move along a vertical line so that the projected image can shift up or down.

In the present invention, a non-telecentric illumination system is used, which is relatively cheaper than a telecentric illumination system. Furthermore, the light beam from the non-telecentric illumination system will converge after reflection from the reflective light valve. Thus, a smaller projection lens can be used to collect the light beam and save the manufacturing cost. In a word, the single reflective light valve projection device of the present invention can provide a large degree of offset in side projection at a relatively low production cost.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic drawing of a conventional side-projection device having large offset.

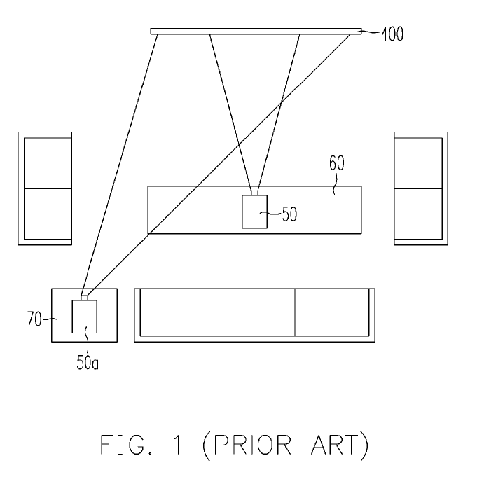

FIG. 2 is a diagram showing a plurality of projected images at various projecting angles from a conventional single reflective light valve projection device controlled by an electronic compensation system.

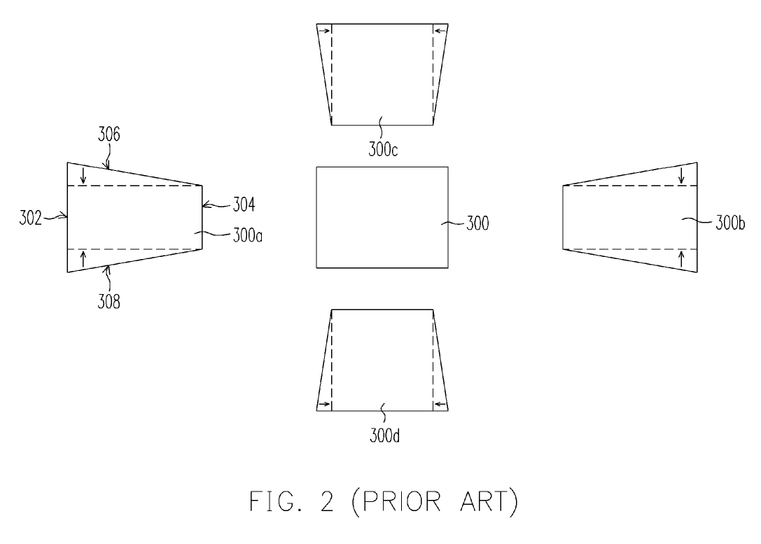

FIG. 3 is a diagram showing the structural layout of a conventional single reflective light valve projection device.

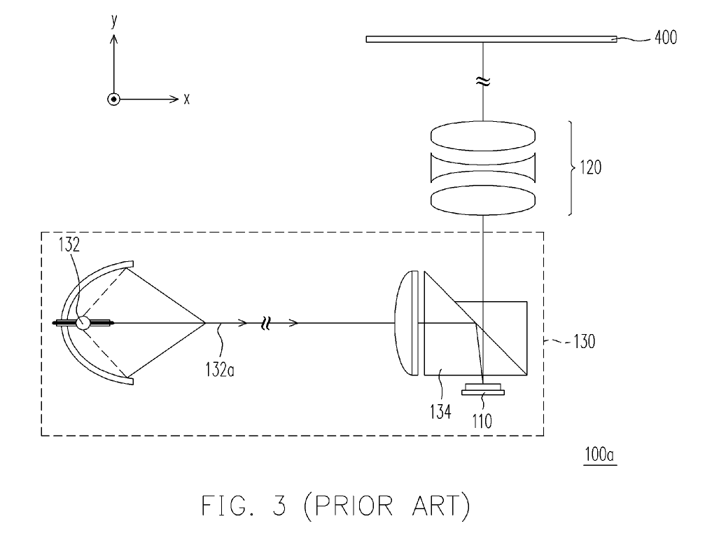

FIG. 4 is a diagram showing the maximum degree of shifting an image permitted by a conventional single reflective light valve projection device.

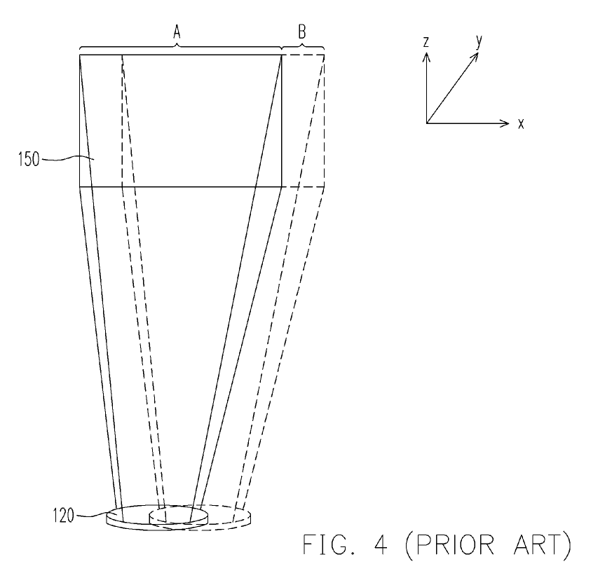

FIG. 5 is a diagram showing the structural layout of another conventional single reflective light valve projection device.

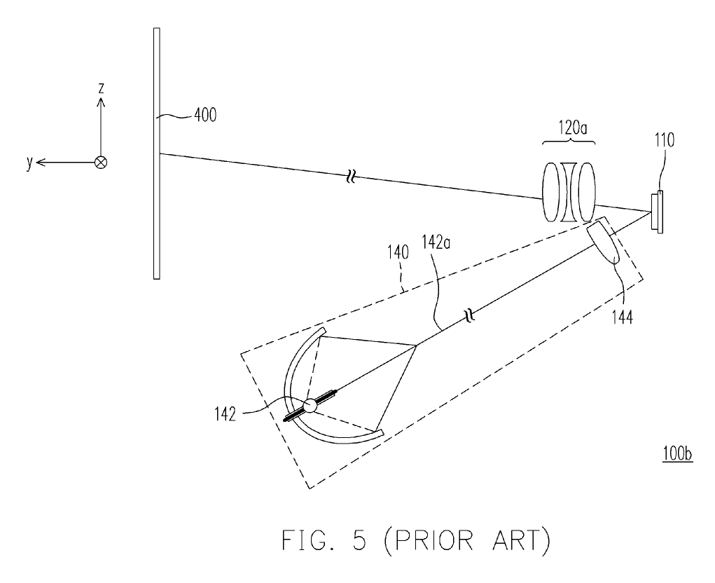

FIG. 6 is drawing showing the relative positions of the reflective light valve, the lens and the projection lens inside a conventional single reflective light valve projection device.

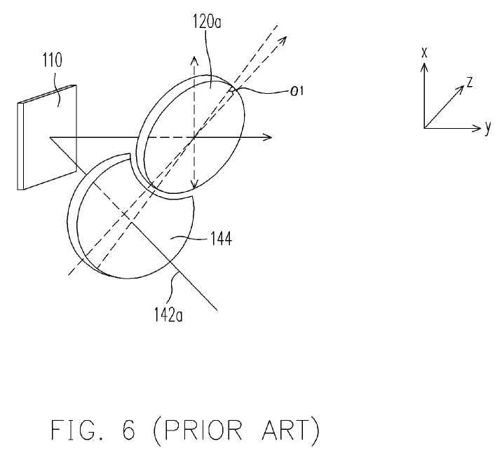

FIG. 7 is a diagram showing the image projected on a screen by another conventional reflective light valve projection device.

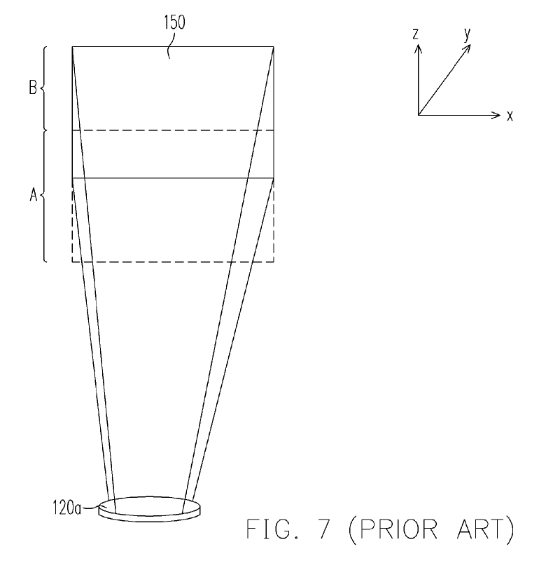

FIG. 8 is a diagram showing the structure of a single reflective light valve projection device according to a first embodiment of the present invention.

FIG. 9 is a drawing showing the relative positions of the reflective light valve, the lens and the projection lens inside a single reflective light valve projection device according to the first embodiment of the present invention.

FIG. 10 is a diagram showing the image projected on a screen by the single reflective light valve projection device according to the first embodiment of the present invention.

FIG. 11 is a diagram showing the structure of a single reflective light valve projection device according to a second embodiment of the present invention.

FIG. 12 is a drawing showing the relative positions of the reflective light valve, the lens and the projection lens inside a single reflective light valve projection device according to the second embodiment of the present invention.

FIG. 13 is a diagram showing the image projected on a screen by the single reflective light valve projection device according to the second embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

### First Embodiment

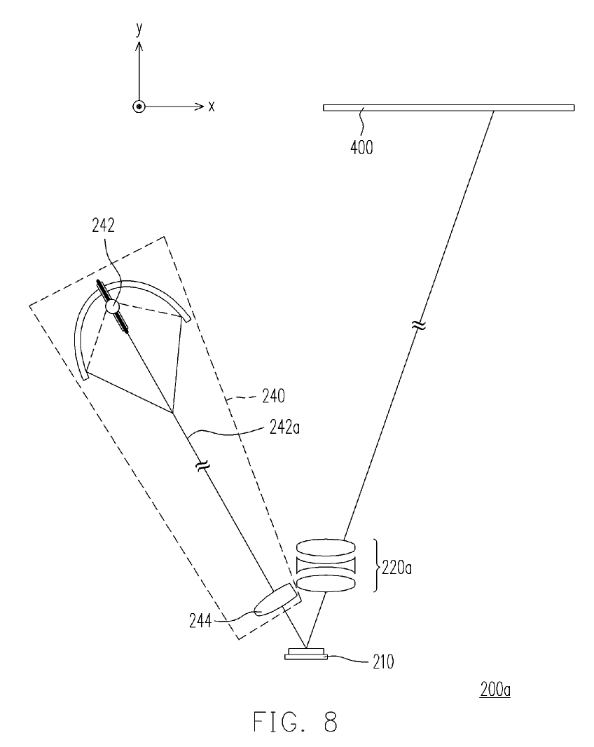

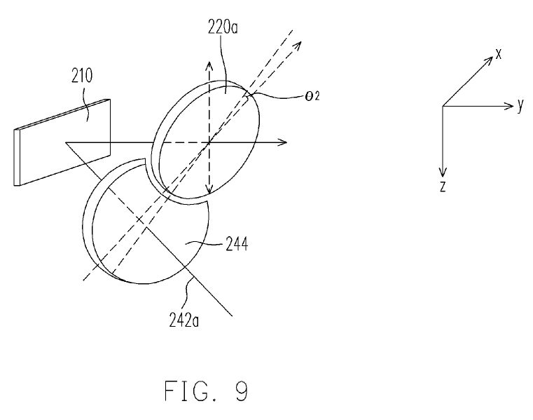

FIG. 8 is a diagram showing the structure of a single reflective light valve projection device according to a first embodiment of the present invention. FIG. 9 is a drawing showing the relative positions of the reflective light valve, the lens and the projection lens inside a single reflective light valve projection device according to the first embodiment of the present invention. As shown in FIGS. 8 and 9, the present embodiment provides a single reflective light valve projection device 200a suitable for performing side projection along a horizontal line (an X-axis). The single reflective light valve projection device 200a includes a non-telecentric illumination system 240, a projection lens 220a and a reflective light valve 210. The non-telecentric illumination device 240 further includes a light source 242 and a lens 244.

In the aforementioned single reflective light valve projection device 200a, the light source 242 provides a light beam 242a and the lens 244 is disposed in the transmission path of the light beam 242a. The projection lens 220a is disposed behind the lens 244 and in the transmission path of the light beam 242a. The reflective light valve 210 is disposed between the lens 244 and the projection lens 220a and in the transmission path of the light beam 242a. The reflective light valve 210 has many rows of pixels set along a horizontal line (the X-axis). Furthermore, a line joining the center of the projection lens 220a and the center of the lens 244 forms an angle θ2 smaller than π/4 with respect to the horizontal line (the X-axis) to perform horizontal side projection (along the X-axis).

In the aforementioned single reflective light valve projection device 200a, the light source 242 provides a light beam 242a that passes through the lens 244. After passing through the lens 244, the light beam 242a converges and impinges upon the reflective light valve 210. The lens 244 is a transparent lens with a curved surface, a reflecting mirror with a plane surface or a reflecting mirror with a curved surface, for example. The lens 244 in FIG. 8 is a transparent lens with a curved surface. Furthermore, the reflective light valve 210 is a digital micro-mirror device (DMD) or a liquid crystal on silicon (LCOS) panel, for example. In FIG. 8, the reflective light valve 210 is a digital micro-mirror device having many pixel units, each of which has at least an ‘ON’ state and an ‘OFF’ state.

After the light beam 242a is incident on the reflective light valve 210, when the pixel unit is in ‘ON’ state, the light beam 242a is reflected to the projection lens 220a by the pixel unit. On the other hand, when the pixel unit is in ‘OFF state, the light beam 242a is reflected away from the projection lens 220a by the pixel unit. The light beam 242a reflected to the projection lens 220a will first converge at a point about 10˜100 mm in front of the reflective light valve 210 before being projected on the screen 400 through the projection lens 220a.

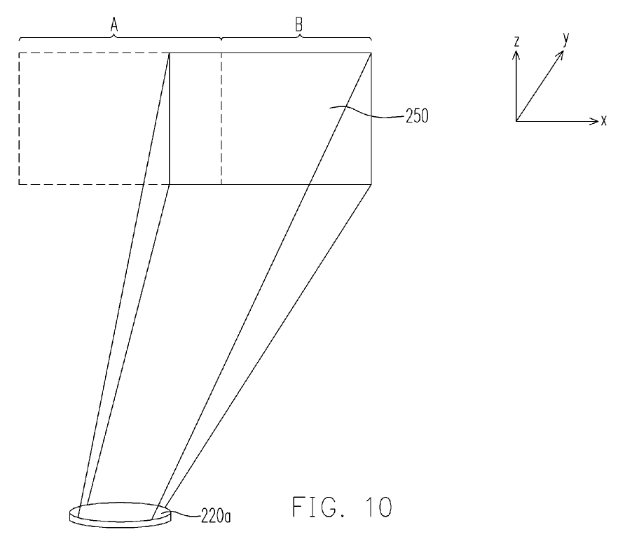

FIG. 10 is a diagram showing the projected image on a screen by the single reflective light valve projection device according to the first embodiment of the present invention. As shown in FIGS. 8 and 10, the projection lens 220a is disposed on the right side of the lens 244. Thus, the image 250 projected from the projection lens 220a will offset to the right. Hence, this type of projection device can provide considerable side offset exceeding 100% or even as high as 120%, for example. In other words, the single reflective light valve projection device of the present embodiment can be used to perform right-side projection of a large angle. The degree of offset can be computed as mentioned, thus, detailed description is not repeated.

In the present embodiment, if left-side projection of a large angle is desired, the single reflective light valve projection device 200a can be flipped over. Through image-inversion processing software, an upright image is formed. Hence, the single reflective light valve projection device 200a can be used to perform side projection of a large angle either from the right or from the left.

### Second Embodiment

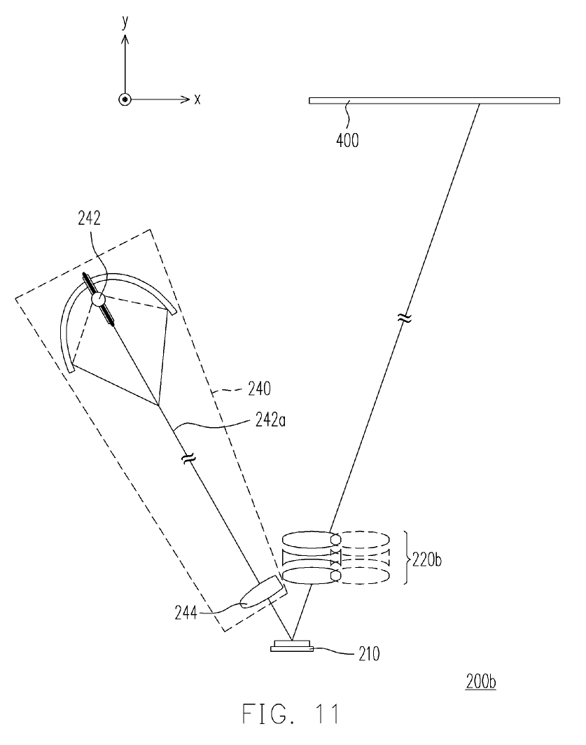

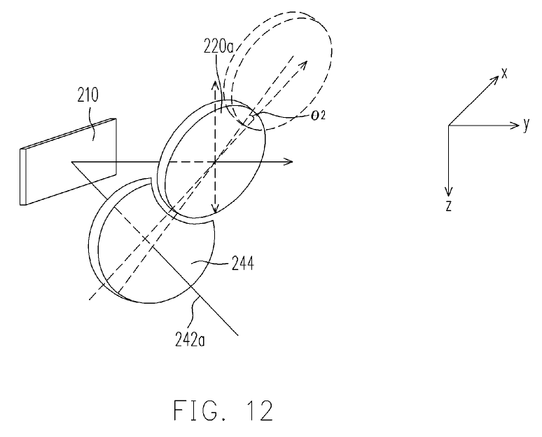

FIG. 11 is a diagram showing the structure of a single reflective light valve projection device according to a second embodiment of the present invention. FIG. 12 is drawing showing the relative positions of the reflective light valve, the lens and the projection lens inside a single reflective light valve projection device according to the second embodiment of the present invention. As shown in FIGS. 11 and 12, the present embodiment provides a single reflective light valve projection device 200b capable of performing side projection along a horizontal line (X-axis) and/or a vertical line (Z-axis). The single reflective light valve projection device 200b includes a non-telecentric illumination system 240, a projection lens 220b and a reflective light valve 210. The non-telecentric illumination system 240 further includes a light source 242 and a lens 244.

In the single reflective light valve projection device 200b, the light source 242 provides a light beam 242a and the lens 244 is disposed in the transmission path of the light beam 242a. The projection lens 220b is disposed behind the lens 244 and in the transmission path of the light beam 242a. The reflective light valve 210 is disposed between the lens 244 and the projection lens 220b and in the transmission path of the light beam 242a. The reflective light valve 210 has many rows of pixels set along a horizontal line (the X-axis). Furthermore, the projection lens 220b moves along a horizontal line (the X-axis) in a direction away from the lens 244 so that a side projection with different degree of horizontal offset is possible. In addition, the projection lens 220b can move along the vertical line (the Z-axis) to perform side projection having different horizontal and vertical offset degrees.

In the single reflective light valve projection device 200b, the light source 242 provides a light beam 242a that passes through the lens 244. After passing through the lens 244, the light beam 242a converges and impinges upon the reflective light valve 210. The lens 244 is a transparent lens with a curved surface, a reflecting mirror with a plane surface or a reflecting mirror with a curved surface, for example. The lens 244 in FIG. 11 is a transparent lens with a curved surface. Furthermore, the reflective light valve 210 is a digital micro-mirror device (DMD) or a liquid crystal on silicon (LCOS) panel, for example. In FIG. 11, the reflective light valve 210 is a digital micro-mirror device having many pixel units, each of which has at least an ‘ON’ state and an ‘OFF’ state.

After the light beam 242a impinges on the reflective light valve 210, when the pixel unit is in ‘ON’ state, the light beam 242a is reflected to the projection lens 220b by the pixel unit. On the other hand, when the pixel unit is in ‘OFF state, the light beam 242a is reflected away from the projection lens 220b by the pixel unit. The light beam 242a reflected to the projection lens 220b will first converge at a point about 10˜100mm in front of the reflective light valve 210 before being projected to the screen 400 through the projection lens 220b.

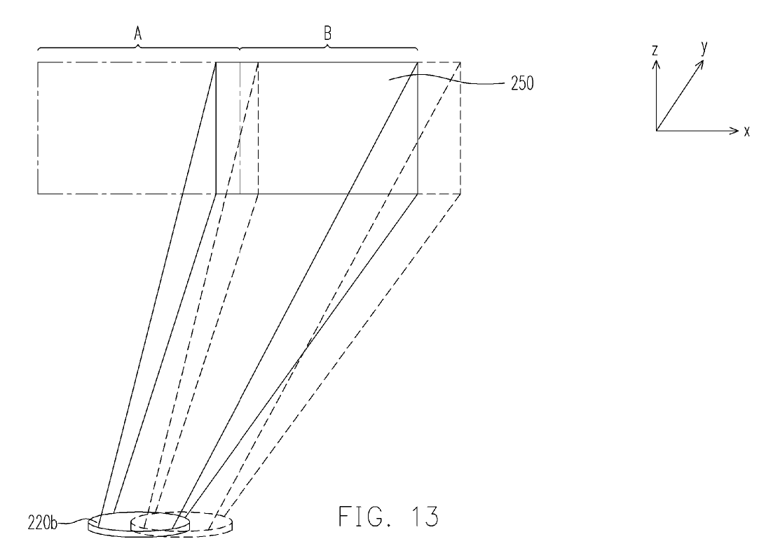

FIG. 13 is a diagram showing the projected image on a screen by the single reflective light valve projection device according to the second embodiment of the present invention. As shown in FIGS. 11 and 13, the projection lens 220b is disposed on the right side of the lens 244. Thus, the image 250 projected from the projection lens 220b will offset to the right. Hence, this type of projection device can provide considerable side offset, for example, exceeding 100% or even as high as 120%. The degree of offset can be computed as mentioned, thus, detailed description is not repeated.

In the present embodiment, if the degree of side offset is insufficient, the image 250 can be shifted further to the right through moving the projection lens 220b along the horizontal line (the X-axis) toward the right. Furthermore, the present embodiment also allows the projection lens 220b to move up and down along a vertical line (the Z-axis). Hence, the image 250 can move up and down following a vertical line (the Z-axis).

In the second embodiment of the present invention, the lens 244 is located on the left side of the projection lens 220b. Thus, the projection lens 220b will interfere with the lens 244 if the projection lens 220b move to the left along the horizontal line (the X-axis). Therefore, the single reflective light valve projection device 200b can only perform right-side projection. However, the single reflective light valve projection device 200b of the present embodiment can be flipped over and through image-processing software, an upright image can be projected on the screen. Hence, the single reflective light valve projection device 200b of the present invention can be used to perform right-side projection of a large angle or left-side projection of a large angle when the single reflective light valve projection device 200b is flipped over.

In summary, the present invention provides a single reflective light valve projection device having a projection lens disposed on the right side of the lens so that the projected image can be highly offset to the right for performing a right-side projection of a large angle. On the other hand, if left-side projection of a large angle is desired, the single reflective light valve projection device can be flipped over and through the inversion software, an upright image can be projected. In another single reflective light valve projection device of the present invention, the projection lens is allowed to move along a horizontal line in a direction away from the lens so that the side projection can have a larger offset. Furthermore, the projection lens is allowed to move along a vertical line so that the projected image from the single reflective light valve projection device can shift either up or down along the vertical line.

In addition, a non-telecentric illumination system instead of a telecentric illumination system is deployed in the present invention so that the production cost is lower. Moreover, the light beam from the non-telecentric illumination system will converge after reflection from the reflective light valve. Hence, a smaller projection lens can be used to collect the light beam so that some production cost is further reduced. In other words, the single reflective light valve projection device of the present invention can provide a larger offset in side projection at a low production cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A single reflective light valve projection device for providing side projection along a horizontal line, the device comprising:
a non-telecentric illumination system, comprising:
a light source for providing a light beam;
a lens disposed in the transmission path of the light beam;
a projection lens disposed behind the lens and in the transmission path of the light beam; and
a reflective light valve disposed between the lens and the projection lens and in the transmission path of the light beam, wherein the reflective light valve has rows of pixels along the horizontal line and a line joining the center of the projection lens and the center of the lens forms an angle smaller than π/4 with respect to the horizontal line to perform side projection along the horizontal line.

2. The projection device of claim 1, wherein the reflective light valve comprises a digital micro-mirror device (DMD) or a liquid crystal on silicon (LCOS) panel.

3. The projection device of claim 1, wherein the lens comprises a transparent lens with a curved surface.

4. The projection device of claim 1, wherein the lens comprises a reflecting mirror with a plane surface.

5. The projection device of claim 1, wherein the lens comprises a reflecting mirror with a curved surface.

6. The projection device of claim 1, wherein the light beam converges at a point about 10 mm to 100 mm in front of the reflective light valve.

7. The projection device of claim 1, wherein the horizontal offset in the side projection exceeds 100%.

8. A single reflective light valve projection device for providing a side projection along a horizontal line and/or a vertical line, the device comprising:
a non-telecentric illumination system, comprising:
a light source for providing a light beam;
a lens disposed in the transmission path of the light beam;
a projection lens disposed behind the lens and in the transmission path of the light beam; and
a reflective light valve disposed between the lens and the projection lens and in the transmission path of the light beam, wherein the reflective light valve has rows of pixels along the horizontal line and the projection lens moves along the horizontal line in a direction away from the lens to perform side projection having different degrees of horizontal offset.

9. The projection device of claim 8, wherein the reflective light valve comprises a digital micro-mirror device (DMD) or a liquid crystal on silicon (LCOS) panel.

10. The projection device of claim 8, wherein the lens comprises a transparent lens with a curved surface.

11. The projection device of claim 8, wherein the lens comprises a reflecting mirror with a plane surface.

12. The projection device of claim 8, wherein the lens comprises a reflecting mirror with a curved surface.

13. The projection device of claim 8, wherein the light beam converges at a point about 10 mm to 100 mm in front of the reflective light valve.

14. The projection device of claim 8, wherein the projection lens moves along the vertical line to perform side projection having different horizontal offset and vertical offset simultaneously.
